(19) United States
(12) Patent Application Publication
(10) Pub. No.: US 2023/0222537 A1
(43) Pub. Date: Jul. 13, 2023

(54) CAMPAIGN RECOMMENDATIONS ENGINE FOR OPTIMAL ENGAGEMENT

(71) Applicant: IGT, Las Vegas, NV (US)

(72) Inventors: Prasad Inamdar, San Francisco, CA (US); Rajat Khanda, Fremont, CA (US); Praveen KrishnanNair, Fremont, CA (US); Thomas S. Duane, Portland, OR (US)

(21) Appl. No.: 17/570,493

(22) Filed: Jan. 7, 2022

(51) Int. Cl. G06Q 30/02

(52) U.S. Cl. CPC G06Q 30/0244; G06Q 30/0243

(57) ABSTRACT

In certain embodiments, the present disclosure relates to generating a campaign for a promoted electronic game. According to one embodiment, a method for generating a campaign for a promoted electronic game can comprise obtaining content data for each player of a plurality of players of an electronic game other than the promoted electronic game and campaign data for each campaign of a plurality of campaigns other than the campaign for the promoted game. Recommendation data can be generated for the campaign for the promoted electronic game. The recommendation data can indicate a plurality of possible campaigns, each campaign of the plurality of possible campaigns comprising a plurality of actions related to the promoted electronic game. Generating the recommendation data can comprise applying a recommendation model to the content data and the campaign data. A user interface comprising details of the generated recommendation data can then be presented

### BACKGROUND

The present disclosure is generally directed to electronic gaming, in particular, toward automated generation of recommendations for a campaign to promote an electronic game.

Marketing campaigns for promoting electronic games have a wide range of Return On Investment (ROI) based on content of the campaign, structure of the campaign, players targeted, timing, etc. Player engagement through regular promotions based on their game preferences and personalized journey can improve ROI. However, revenue predictability is uncertain without the ability to engage players through continual rewards in a responsible way. Operators, marketing administrators, and/or others do not have time or available data and analysis to recommend best possible campaigns as there are multiple data points with different statistical interpretation. Hence, there is a need in the art for methods and systems for automated generation of recommendations for a campaign to promote an electronic game.

### BRIEF SUMMARY

In certain embodiments, the present disclosure relates to generating a campaign for a promoted electronic game. According to one embodiment, a method for generating a campaign for a promoted electronic game can comprise obtaining content data for each player of a plurality of players of an electronic game other than the promoted electronic game and campaign data for each campaign of a plurality of campaigns other than the campaign for the promoted game.

For example, the content data can comprise historical data for each player of the plurality of players of the electronic game other than the promoted electronic game. Additionally, or alternatively, the content data can comprise player Key Performance Indicators (KPIs) for each player of the plurality of players of the electronic game other than the promoted electronic game. The campaign data can comprise, for example, historical data for each campaign of the plurality of campaigns other than the campaign for the promoted electronic game. Additionally, or alternatively, the campaign data can comprise campaign KPIs for each campaign of the plurality of campaigns other than the campaign for the promoted electronic game.

Recommendation data can be generated for the campaign for the promoted electronic game. The recommendation data can indicate a plurality of possible campaigns, each campaign of the plurality of possible campaigns can comprise a plurality of actions related to the promoted electronic game. Generating the recommendation data can comprise applying a recommendation model to the content data and the campaign data. For example, applying the recommendation model to the content data can comprise applying a collaborative filtering model to the content data. According to one embodiment, applying the recommendation model to the campaign data can comprise applying a parallel collaborative filtering model to the campaign data. Additionally, or alternatively, applying the recommendation model to the campaign data can comprise applying a multi-output regression model to the campaign data.

A user interface comprising details of the generated recommendation data can then be presented. A selection of one of the campaigns of the plurality of possible campaigns can be received through the user interface. An indication of the selected campaign can then be provided to a gaming venue management system of a gaming venue in which the promoted electronic game is implemented.

According to another embodiment, a campaign generation system can comprise a processor and a memory coupled with and readable by the processor. The memory can store therein a set of instructions which, when executed by the processor, causes the processor to obtain content data for each player of a plurality of players of an electronic game other than a promoted electronic game and campaign data for each campaign of a plurality of previous campaigns for games other than the promoted electronic game.

For example, the content data can comprise historical data for each player of the plurality of players of the electronic game other than the promoted electronic game and player KPIs for each player of the plurality of players of the electronic game other than the promoted electronic game. The campaign data can comprise, for example, historical data for each campaign of the plurality of campaigns other than the campaign for the promoted electronic game and campaign KPIs for each campaign of the plurality of campaigns other than the campaign for the promoted electronic game.

The instructions can further cause the processor to generate recommendation data for a campaign for the promoted electronic game. The recommendation data can indicate a plurality of possible campaigns and can, in some cases, comprise a rating for each campaign of the plurality of possible campaigns and a prediction for each campaign of the plurality of possible campaigns. Each campaign of the plurality of possible campaigns can comprise a plurality of actions available to be performed in the promoted electronic game. Generating the recommendation data can comprise applying a recommendation model to the content data and the campaign data. According to one embodiment, applying the recommendation model to the content data can comprise applying a collaborative filtering model to the content data. Applying the recommendation model to the campaign data can comprise, for example, applying a parallel collaborative filtering model to the campaign data. Additionally, or alternatively, applying the recommendation model to the campaign data can comprise applying a multi-output regression model to the campaign data.

The instructions can further cause the processor to post-process the recommendation data based on the rating for each campaign of the plurality of possible campaigns and the prediction for each campaign of the plurality of possible campaigns, select a campaign of the plurality of possible campaigns based on the post-processing of the recommendation data, and present a user interface comprising the selected campaign. In some cases, the instructions can further cause the processor to receive, through the user interface, an indication of an approval of the selected campaign and provide an indication of the selected campaign to a gaming venue management system of a gaming venue in which the promoted electronic game is implemented.

According to yet another embodiment, a computer-readable storage medium can comprise a set of instructions stored therein which, when executed by a processor, causes the processor to obtain content data for each player of a plurality of players of an electronic game other than a promoted electronic game and campaign data for each campaign of a plurality of previous campaigns for games other than the promoted electronic game. The content data can comprise historical data for each player of the plurality of players of the electronic game other than the promoted electronic game and player KPIs for each player of the plurality of players of the electronic game other than the promoted electronic game. The campaign data can comprise historical data for each campaign of the plurality of campaigns other than the campaign for the promoted electronic game and campaign KPIs for each campaign of the plurality of campaigns other than the campaign for the promoted electronic game. The recommendation data can comprise a rating for each campaign of the plurality of campaigns and a prediction for each campaign of the plurality of possible campaigns.

The instructions can further cause the processor to generate recommendation data for a campaign for the promoted electronic game. The recommendation data can indicate a plurality possible campaigns and each campaign of the plurality of possible campaigns can comprise a plurality of actions available to be performed in the promoted electronic game. Generating the recommendation data can comprise applying a recommendation model to the content data and the campaign data. Applying the recommendation model to the content data can comprise applying a collaborative filtering model to the content data. Applying the recommendation model to the campaign data can comprise applying a parallel collaborative filtering model to the campaign data. Additionally, or alternatively, applying the recommendation model to the campaign data can comprise applying a multi-output regression model to the campaign data.

The instructions can further cause the processor to post-process the recommendation data based on the rating for each campaign of the plurality possible campaigns and the prediction for each campaign of the plurality of possible campaigns, select campaign of the plurality of possible campaigns based on the post-processing of the recommendation data and a geographic region in which the promoted electronic game is implemented, the geographic region comprising one of a plurality of geographic regions having different regulations applicable to electronic games, and present a user interface comprising details of the selected campaign.

Additional features and advantages are described herein and will be apparent from the following Description and the figures.

### BRIEF DESCRIPTION OF THE SEVERAL VIEWS OF THE DRAWINGS

FIG. 1 is a block diagram illustrating systems and components of an exemplary environment in which embodiments of the present disclosure may be implemented.

FIG. 2 is a block diagram conceptually illustrating a framework for making campaign recommendations according to one embodiment of the present disclosure.

FIG. 3 is a block diagram illustrating functional components of an exemplary campaign generation system in which embodiments of the present disclosure may be implemented.

FIG. 4 is a flowchart illustrating an exemplary process for generating campaign recommendations according to one embodiment of the present disclosure.

FIG. 5 is a flowchart illustrating additional details of an exemplary process for generating campaign recommendations according to one embodiment of the present disclosure.

### DETAILED DESCRIPTION

Embodiments of the present disclosure will be described in connection with automated generation of recommendations for a campaign to launch a promoted electronic game. Generally speaking, embodiments described herein comprise collecting data from various electronic games and players of those games. This data can include, but is not limited to, historical data for the players and the electronic games. Historical data related to various previous campaigns can also be collected. From this data, recommendations for a marketing campaign can be generated. These recommendations and the campaign can include various actions that can be implemented on the promoted electronic game including, but not limited to, free spins, proposed tournament play, and others. Such targeted campaigns, when implemented, can increase player engagement with the promoted electronic game and increase return on investment for a casino or other gaming venue offering the game.

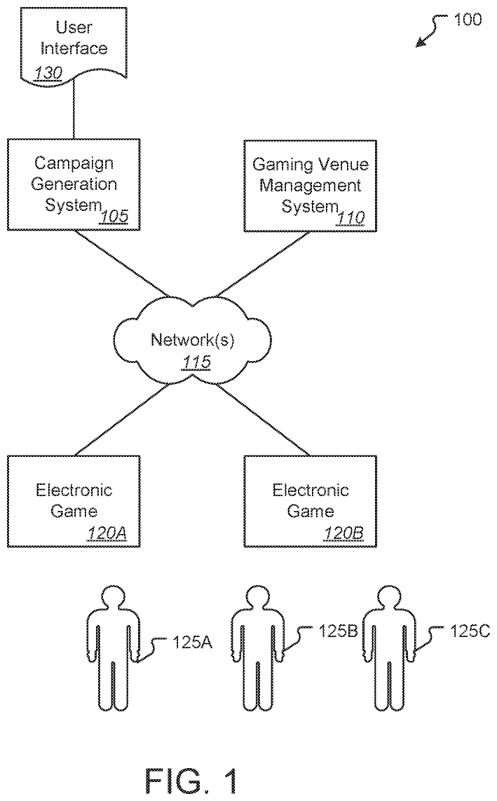

FIG. 1 is a block diagram illustrating systems and components of an exemplary environment in which embodiments of the present disclosure may be implemented. More specifically, this environment 100 can represent an online or physical casino or other gaming venue. This environment can include a campaign generation system 105 and gaming venue management system 110 coupled with one or more wired and/or wireless wide-area and/or local-area communications networks 115. A number of electronic games 120A and 120B can also be coupled with the communications network(s) 115 and made available to a number of players 125A-125C.

According to one embodiment, the campaign generation system 105 can be adapted to generate a marketing campaign for a new or promoted electronic game 120A. To do so, the campaign generation system 105 can collect or otherwise obtain, e.g., from the gaming venue management system 110, content data for the players 125A-125C of the electronic games 120A and 120B. For example, the content data can comprise historical data for each player. Additionally, or alternatively, the content data can comprise player Key Performance Indicators (KPIs) for each player. The campaign generation system 105 can also maintain or obtain campaign data for previous marketing campaigns. For example, the campaign data can comprise historical data for one or more previous campaigns. Additionally, or alternatively, the campaign data can comprise campaign KPIs for the previous campaigns.

The campaign generation system 105 can then use the content data and the campaign data to generate recommendation data for the campaign for the promoted electronic game 120A. The recommendation data can indicate a plurality of possible campaigns, each campaign of the plurality of possible campaigns can comprise a plurality of actions related to the promoted electronic game 120A. These actions can include, but are not limited to, free spins, proposed tournament play, and other game related actions that can be implemented on the promoted electronic game 120A.

The campaign generation system 105 can provide a user interface 130 comprising details of the generated recommendation data. This user interface 130 can be presented, for example, to a marketing administrator or other user to review the recommendations, make changes to the recommendations, or approve the recommendations for the campaign. Once selected and/or approved through this user interface 130, an indication of the selected campaign can then be provided to the gaming venue management system 110 of the gaming venue in which the electronic game 120A is installed and/or the electronic game 120A itself for implementation of the actions of the campaign in a manner as known in the art.

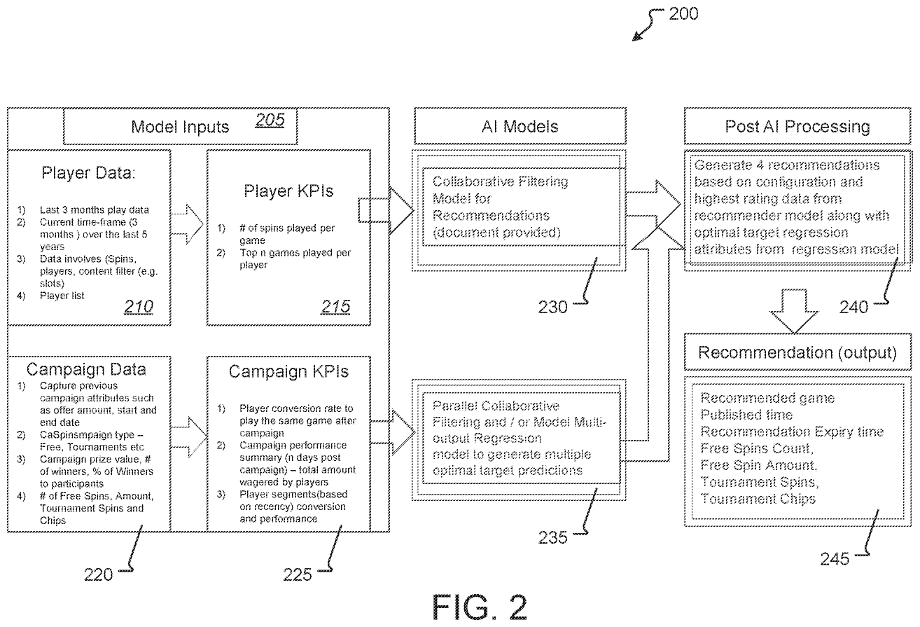

FIG. 2 is a block diagram conceptually illustrating a framework for making campaign recommendations according to one embodiment of the present disclosure. Such a framework 200 can be implemented by the campaign generation system 105 as described above. As noted above, the campaign generation system 105 can collect a number of inputs including player historical data 210, player KPIs 215, campaign data 220, and campaign KPIs.

A number of Artificial Intelligence (AI) models 230 and 235 can be used to generate recommendation data. The recommendation data can indicate a plurality of possible campaigns and can, in some cases, comprise a rating for each campaign of the plurality of possible campaigns and a prediction for each campaign of the plurality of possible campaigns. Generating the recommendation data can comprise applying the recommendation models 230 and 235 to the content data and the campaign data. According to one embodiment, applying the recommendation model to the content data, i.e., the player historical data 210 and player KPIs 215, can comprise applying a collaborative filtering model 230 to the content data. Applying the recommendation model to the campaign data 220 and campaign KPIs 225 can comprise, for example, applying a parallel collaborative filtering and/or multi-output regression model 235 to the campaign data 220 and campaign KPIs 225. The recommendation data generated by the AI models 230 and 235 can include a rating for each campaign of a plurality of possible campaigns and a prediction for each campaign.

The campaign generation system 105 can then apply post-processing 240 to the recommendation data based on the rating for each campaign of the plurality of possible campaigns and the prediction for each campaign of the plurality of possible campaigns. For example, as illustrated here, post processing can generate a number of recommendations based on configuration data and the highest ratings and target regression attributes from the AI models 230 and 235. Also as illustrated in this example, the resulting recommendation data 245 can include, but is not limited to, a recommended game (for a particular player), a recommended publication time for the campaign, a recommended expiration time for the campaign, a free spins count, a free spins amount, a number of tournament spins, a number of tournament chips, and/or other actions of or related to the promoted electronic game.

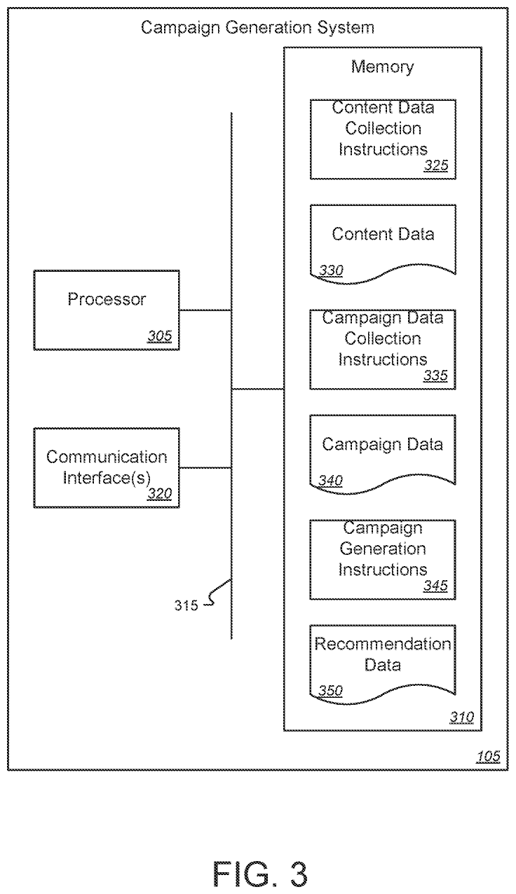

FIG. 3 is a block diagram illustrating functional components of an exemplary campaign generation system in which embodiments of the present disclosure may be implemented. As illustrated in this example, the campaign generation system 105 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the campaign generation system 105 as described herein.

The memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with, one or more communication interfaces 320 via the communications bus 315. The communication interface(s) 320 can comprise, for example, Ethernet, Bluetooth, WiFi, or other type of wired or wireless communications interfaces.

The memory 310 can store therein sets of instructions which, when executed by the processor 305, cause the processor 305 to operate the campaign generation system 105 as described herein. More specifically, the memory 310 can store therein a set of content data collection instructions 325 which, when executed by the processor 305, can cause the processor 305 to obtain content data 330 for each player of a plurality of players 125A-125C of an electronic game 120B other than a promoted electronic game 120A. For example, and as noted above, the content data 330 can comprise historical data for each player of the plurality of players 125A-125C of the electronic game 120B other than the promoted electronic game 120A and player KPIs for each player of the plurality of players 125A-125C of the electronic game 120B other than the promoted electronic game 120A.

The memory 310 can also store therein a set of campaign data collection instructions 335 which, when executed by the processor 305, can cause the processor 305 to obtain campaign data 340 for each campaign of a plurality of previous campaigns for games 120B other than the promoted electronic game 120A. The campaign data 340 can comprise, for example, historical data for each campaign of the plurality of campaigns other than the campaign for the promoted electronic game 120A and campaign KPIs for each campaign of the plurality of campaigns other than the campaign for the promoted electronic game 120A.

The memory 310 can also store therein a set of campaign generation instructions 345. The campaign generation instructions 345, when executed by the processor 305, can further cause the processor 305 to generate recommendation data 350 for a campaign for the promoted electronic game 120A. The recommendation data 350 can indicate a plurality of possible campaigns and can, in some cases, comprise a rating for each campaign of the plurality of possible campaigns and a prediction for each campaign of the plurality of possible campaigns. Each campaign of the plurality of possible campaigns can comprise a plurality of actions available to be performed in the promoted electronic game 120A. Generating the recommendation data 350 can comprise applying a recommendation model 355 to the content data 330 and the campaign data 340. According to one embodiment, applying the recommendation model 355 to the content data 330 can comprise applying a collaborative filtering model to the content data 330. Applying the recommendation model 355 to the campaign data 340 can comprise, for example, applying a parallel collaborative filtering model to the campaign data 340. Additionally, or alternatively, applying the recommendation model 355 to the campaign data 340 can comprise applying a multi-output regression model to the campaign data 340.

The campaign generation instructions 345 can further cause the processor 305 to provide the generated recommendation data 350 to another system through the communication interface 320, e.g., as a user interface 130, receive a selection of a campaign from or based on the recommendation data 350, and initiate the campaign, e.g., by providing campaign data and/or instructions to a gaming venue management system 110 or other system via the communication interfaces 320. In some cases, the campaign generation instructions 345 can cause the processor 305 to first post-process the recommendation data 350 based on the rating for each campaign of the plurality of possible campaigns and the prediction for each campaign of the plurality of possible campaigns, select a campaign of the plurality of possible campaigns based on the post-processing of the recommendation data, and present a user interface 130 comprising the selected campaign. In such cases, the campaign generation instructions 345 can further cause the processor 305 to receive, through the user interface 130, an indication of an approval of the selected campaign and provide an indication of the selected campaign to a gaming venue management system 110 in which the promoted electronic game is implemented.

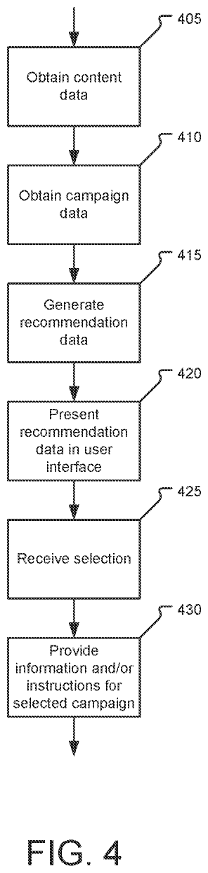

FIG. 4 is a flowchart illustrating an exemplary process for generating campaign recommendations according to one embodiment of the present disclosure. According to one embodiment, and as illustrated in this example, generating a campaign for a promoted electronic game 120A can comprise obtaining 405 content data 330 for each player of a plurality of players 125A-125C of an electronic game 120B other than the promoted electronic game 120A and obtaining 410 campaign data 340 for each campaign of a plurality of campaigns other than the campaign for the promoted game 120A. For example, the content data 330 can comprise historical data for each player of the plurality of players 125A-125C of the electronic game 120B other than the promoted electronic game 120A. Additionally, or alternatively, the content data 330 can comprise player KPIs for each player of the plurality of players 125A-125C of the electronic game 120B other than the promoted electronic game 120A. The campaign data 340 can comprise, for example, historical data for each campaign of the plurality of campaigns other than the campaign for the promoted electronic game 120A. Additionally, or alternatively, the campaign data 340 can comprise campaign KPIs for each campaign of the plurality of campaigns other than the campaign for the promoted electronic game 120A.

Recommendation data 350 can be generated 415 for the campaign for the promoted electronic game 120A. The recommendation data 350 can indicate a plurality of possible campaigns, each campaign of the plurality of possible campaigns can comprise a plurality of actions related to the promoted electronic game. Generating 415 the recommendation data 350 can comprise applying a recommendation model 355 to the content data 330 and the campaign data 340. For example, applying the recommendation model 355 to the content data 330 can comprise applying a collaborative filtering model to the content data 330. According to one embodiment, applying the recommendation model 355 to the campaign data 340 can comprise applying a parallel collaborative filtering model to the campaign data 340. Additionally, or alternatively, applying the recommendation model 355 to the campaign data 340 can comprise applying a multi-output regression model to the campaign data 340.

A user interface 130 comprising details of the generated recommendation data can then be presented 420. A selection of one of the campaigns of the plurality of possible campaigns can be received 425 through the user interface 130. An indication of the selected campaign can then be provided 430 to a gaming venue management system 110 for a gaming venue in which the promoted electronic game 120A is implemented.

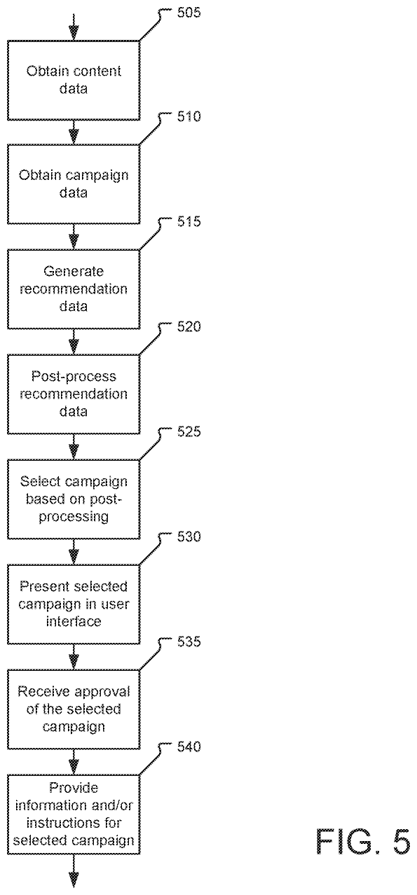

FIG. 5 is a flowchart illustrating additional details of an exemplary process for generating campaign recommendations according to one embodiment of the present disclosure. As illustrated in this example, generating campaign recommendations can comprise obtaining 505 content data 330 for each player of a plurality of players 125A-125C of an electronic game 120B other than a promoted electronic game 120A. For example, the content data 330 can comprise historical data for each player of the plurality of players 125A-125C of the electronic game 120B other than the promoted electronic game 120A and player KPIs for each player of the plurality of players 125A-125C of the electronic game 120B other than the promoted electronic game 120A.

Campaign data 340 can also be obtained 510 for each campaign of a plurality of previous campaigns for games other than the promoted electronic game 120A. The campaign data 340 can comprise, for example, historical data for each campaign of the plurality of campaigns other than the campaign for the promoted electronic game 120A and campaign KPIs for each campaign of the plurality of campaigns other than the campaign for the promoted electronic game 120A.

Recommendation data 350 can be generated 515 for a campaign for the promoted electronic game 120A. The recommendation data 350 can indicate a plurality of possible campaigns and can, in some cases, comprise a rating for each campaign of the plurality of possible campaigns and a prediction for each campaign of the plurality of possible campaigns. Each campaign of the plurality of possible campaigns can comprise a plurality of actions available to be performed in the promoted electronic game 120A. Generating 515 the recommendation data 350 can comprise applying a recommendation model 355 to the content data 330 and the campaign data 340. According to one embodiment, applying the recommendation model 355 to the content data 330 can comprise applying a collaborative filtering model to the content data 330. Applying the recommendation model 355 to the campaign data 340 can comprise, for example, applying a parallel collaborative filtering model to the campaign data 340. Additionally, or alternatively, applying the recommendation model 355 to the campaign data 340 can comprise applying a multi-output regression model to the campaign data 340.

The recommendation data 350 can then be post-processed 520 based on the rating for each campaign of the plurality of possible campaigns and the prediction for each campaign of the plurality of possible campaigns. A campaign can be selected 525 from the plurality of possible campaigns based on the post-processing 520 of the recommendation data 350. A user interface 130 can be presented 530 that indicates and/or describes the selected 525 campaign. In some cases, an indication of an approval of the selected campaign can be received 535 through the user interface 130. In response, an indication of the selected campaign can be provided 540 to a gaming venue management system in which the promoted electronic game is implemented.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

1. A method for generating a campaign for a promoted electronic game, the method comprising:
obtaining, by a processor of a campaign generation system, from a first gaming system, content data for each player of a plurality of players of an electronic game executing on the first gaming system, the content data collected by the first gaming system during and based on execution of the electronic game, and the electronic game executing on the first gaming system comprising an electronic game other than the promoted electronic game;
obtaining, by the processor of the campaign generation system, from a second gaming system, content data for each player of a plurality of players of an electronic game executing on the second gaming system, the content data collected by the second gaming system during and based on execution of the electronic game, and the electronic game executing on the second gaming system comprising an electronic game other than the promoted electronic game;
obtaining, by the processor of the campaign generation system, campaign data for each campaign of a plurality of campaigns other than the campaign for the promoted game;
generating, by the processor of the campaign generation system, recommendation data for the campaign for the promoted electronic game, the recommendation data indicating a plurality of possible campaigns, each campaign of the plurality of possible campaigns comprising a plurality of game related actions implemented in and related to the promoted electronic game when the promoted electronic game is executed by a third gaming system and wherein generating the recommendation data comprises applying a recommendation model to the content data from the first gaming system, the content data from the second gaming system and the campaign data; and
presenting, by the processor of the campaign generation system, a user interface comprising details of the generated recommendation data.

2. The method of claim 1, wherein the content data from the first gaming system and the content data from the second gaming system comprises historical data for each player of the plurality of players of the electronic game executed by the first gaming system and the electronic game executed by the second gaming system.

3. The method of claim 2, wherein the content data from the first gaming system and the content data from the second gaming system further comprises player Key Performance Indicators (KPIs) for each player of the plurality of players of the electronic game executed by the first gaming system and the electronic game executed by the second gaming system.

4. The method of claim 3, wherein applying the recommendation model to the content data from the first gaming system and the content data from the second gaming system comprises applying a collaborative filtering model to the content data from the first gaming system and the content data from the second gaming system.

5. The method of claim 1, wherein the campaign data comprises historical data for each campaign of the plurality of campaigns other than the campaign for the promoted electronic game.

6. The method of claim 5, wherein the campaign data further comprises campaign KPIs for each campaign of the plurality of campaigns other than the campaign for the promoted electronic game.

7. The method of claim 6, wherein applying the recommendation model to the campaign data comprises applying a parallel collaborative filtering model to the campaign data.

8. The method of claim 6, wherein applying the recommendation model to the campaign data comprises applying a multi-output regression model to the campaign data.

9. The method of claim 1, further comprising:
receiving, by the processor of the campaign generation system, through the user interface, a selection of one of the campaigns of the plurality of possible campaigns; and
providing, by the processor of the campaign generation system, an indication of the selected campaign to a gaming venue management system in which the promoted electronic game is implemented.

10. A campaign generation system comprising:
a processor; and
a memory coupled with and readable by the processor and storing therein a set of instructions which, when executed by the processor, causes the processor to:
obtain, from a first gaming system, content data for each player of a plurality of players of an electronic game executing on the first gaming system, the content data collected by the first gaming system during and based on execution of the electronic game, and the electronic game executing on the first gaming system comprising an electronic game other than a promoted electronic game;
obtaining, by the processor of the campaign generation system, from a second gaming system, content data for each player of a plurality of players of an electronic game executing on the second gaming system, the content data collected by the second gaming system during and based on execution of the electronic game, and the electronic game executing on the second gaming system comprising an electronic game other than the promoted electronic game;
obtain campaign data for each campaign of a plurality of previous campaigns for games other than the promoted electronic game;
generate recommendation data for a campaign for the promoted electronic game, the recommendation data indicating a plurality of possible campaigns, each campaign of the plurality of possible campaigns comprising a plurality of game related actions available to be performed in the promoted electronic game when the promoted electronic game is executed by a third gaming system, wherein generating the recommendation data comprises applying a recommendation model to the content data from the first gaming system, the content data from the second gaming system, and the campaign data, and wherein the recommendation data comprises a rating for each campaign of the plurality of possible campaigns and a prediction for each campaign of the plurality of possible campaigns;
post-process the recommendation data based on the rating for each campaign of the plurality of possible campaigns and the prediction for each campaign of the plurality of possible campaigns;
select a campaign of the plurality of possible campaigns based on the post-processing of the recommendation data; and
present a user interface comprising details of the selected campaign.

11. The campaign generation system of claim 10, wherein the content data from the first gaming system and the content data from the second gaming system comprises historical data for each player of the plurality of players of the electronic game executed by the first gaming system and the electronic game executed by the second gaming system and player Key Performance Indicators (KPIs) for each player of the plurality of players of the electronic game executed by the first gaming system and the electronic game executed by the second gaming system, and wherein applying the recommendation model to the content data from the first gaming system and the content data from the second gaming system comprises applying a collaborative filtering model to the content data.

12. The campaign generation system of claim 10, wherein the campaign data comprises historical data for each campaign of the plurality of campaigns other than the campaign for the promoted electronic game and campaign KPIs for each campaign of the plurality of campaigns other than the campaign for the promoted electronic game.

13. The campaign generation system of claim 12, wherein applying the recommendation model to the campaign data comprises applying a parallel collaborative filtering model to the campaign data.

14. The campaign generation system of claim 12, wherein applying the recommendation model to the campaign data comprises applying a multi-output regression model to the campaign data.

15. The campaign generation system of claim 10, wherein the instructions further cause the processor to:
receive, through the user interface, an indication of an approval of the selected campaign; and
provide an indication of the selected campaign to a gaming venue management system in which the promoted electronic game is implemented.

16. A computer-readable storage medium comprising a set of instructions stored therein which, when executed by a processor, causes the processor to:
obtain, from a first gaming system, content data for each player of a plurality of players of an electronic game executing on the first gaming system, the content data collected by the first gaming system during and based on execution of the electronic game, and the electronic game executing on the first gaming system comprising an electronic game other than a promoted electronic game;
obtaining, by the processor of the campaign generation system, from a second gaming system, content data for each player of a plurality of players of an electronic game executing on the second gaming system, the content data collected by the second gaming system during and based on execution of the electronic game, and the electronic game executing on the second gaming system comprising an electronic game other than the promoted electronic game;
obtain campaign data for each campaign of a plurality of previous campaigns for games other than the promoted electronic game;
generate recommendation data for a campaign for the promoted electronic game, the recommendation data indicating a plurality possible campaigns, each campaign of the plurality of possible campaigns comprising a plurality of game related actions available to be performed in the promoted electronic game when the electronic game is executed by a third gaming system, wherein generating the recommendation data comprises applying a recommendation model to the content data from the first gaming system, the content data from the second gaming system and the campaign data, and wherein the recommendation data comprises a rating for each campaign of the plurality of campaigns and a prediction for each campaign of the plurality of possible campaigns;
post-process the recommendation data based on the rating for each campaign of the plurality possible campaigns and the prediction for each campaign of the plurality of possible campaigns;
select campaign of the plurality of possible campaigns based on the post-processing of the recommendation data and a geographic region in which the promoted electronic game is implemented, the geographic region comprising one of a plurality of geographic regions having different regulations applicable to electronic games; and
present a user interface comprising details of the selected campaign.

17. The computer-readable storage medium of claim 16, wherein the content data from the first gaming system and the content data from the second gaming system comprises historical data for each player of the plurality of players of the electronic game executed by the first gaming system and the electronic game executed by the second gaming system and player Key Performance Indicators (KPIs) for each player of the plurality of players of the electronic game executed by the first gaming system and the electronic game executed by the second gaming system, and wherein applying the recommendation model to the content data from the first gaming system and the content data from the second gaming system comprises applying a collaborative filtering model to the content data.

18. The computer-readable storage medium of claim 16, wherein the campaign data comprises historical data for each campaign of the plurality of campaigns other than the campaign for the promoted electronic game and campaign KPIs for each campaign of the plurality of campaigns other than the campaign for the promoted electronic game.

19. The computer-readable storage medium of claim 18, wherein applying the recommendation model to the campaign data comprises applying a parallel collaborative filtering model to the campaign data.

20. The computer-readable storage medium of claim 18, wherein applying the recommendation model to the campaign data comprises applying a multi-output regression model to the campaign data.
